(19) United States
(12) Patent Application Publication
(10) Pub. No.: US 2010/0012590 A1
(43) Pub. Date: Jan. 21, 2010

(54) METHOD AND SYSTEM FOR TREATMENT OF WATER

(75) Inventor: Wayne Slark, Kingsport, TN (US)

Correspondence Address: MOORE & VAN ALLEN PLLC, P.O. BOX 13706, Research Triangle Park, NC, 27709, US

(73) Assignee: PDW TECHNOLOGY, LLC, WEST END, NC (US)

(21) Appl. No.: 12/463,806

(22) Filed: May 11, 2009

Related U.S. Application Data
(60) Provisional application No. 61/051,926, filed on May 9, 2008.

(51) Int. Cl. B01D 15/36

(52) U.S. Cl. 210/664; 210/264

(57) ABSTRACT

A method and a device for the treatment of water. The device has a housing comprising an inlet for receiving and an outlet for discharging a volume of water; a first filter media, positioned within the housing comprising an acidic cation exchange resin capable of exchanging at least a portion of metal cations in the volume of water with non-metal cations such that the volume of water exiting the first filter media is reduced in metal cation content; and a second filter media positioned within the housing comprising a weakly basic anion exchange resin capable of exchanging at least a portion of the basic anions in the volume of water, where the first filter media or the second filter media are optionally mixed with a particulate activated carbon. Methods of treating water using the device are disclosed and described.

### CROSS-REFERENCE TO RELATED APPLICATION

This application claims the benefit of U.S. Provisional Application No. 61/051,926 filed May 9, 2008, the entire disclosures of which is incorporated herein by reference in their entirety.

### FIELD OF INVENTION

The present invention relates to water treatment and more particularly to the provision of treated water substantially free of both organic and ionic contaminants.

### BACKGROUND

High purity water is required for many purposes, including use in analysis, medicine and biology, as well as for personal use such as drinking and cleaning. Standards for water purity for various uses have been established by a number of professional organizations. The American Society for Testing and Materials (ASTM), for example, classifies purified water into Types I, II, III, and IV, based upon maximum allowable impurities. One measurement commonly employed for quantifying the quality of water is specific resistivity, which is measured by electrical resistance, expressed in megohm/cm at 25° C., as a measure of ionic contamination. Pure water has a theoretical resistivity of 18.2 and water can be provided to various resistivities approaching this value. Non-ionic contaminants such as organic materials and particulates are monitored by other analytical techniques and maximum values are sometimes specified.

Water is purified by a number of techniques, which are often used in combinations, for providing the highest purity. These techniques include filtration, single or multiple distillation, sorption and ion exchange. Water initially treated by distillation or reverse-osmosis filtration is often “polished” or further purified by passage through activated carbon beds to sorb residual materials, principally organics, mixed beds of anion and cation exchange resins to remove residual ions, and then finally filtered through a microporous filter media to remove residual particulates. Water of 18 megohm/cm resistivity and comprising low organic content can be thus provided by the aforementioned techniques.

Unfortunately, activated carbons may contain ionic impurities, and also may collect microorganisms, which are subsequently released into the water. They are therefore normally used prior to treatment of the water with mixed ion (cation and anionic) exchange resins which remove the ions released. These resins, however, are organic and may release trace quantities of organic contamination into the water. Such contamination is usually small, measured in the parts per billion range, and presents no undue problems for many uses. However, for some applications, for example trace organic analysis by high performance liquid chromatography (HPLC), such contamination can produce significant interference. Further, in home or commercial cleaning applications, trace contaminates may leave residue on evaporated water. Thus, cleaning surfaces cannot be left to dry but must be wiped down to remove contamination residue.

The need for improved techniques to reduce organic contaminants for critical applications is described in an article by Poirer and Sienkilwicz, entitled “Organic-free Water”, American Laboratory, December 1980, pages 69-75. This article describes a device utilizing oxidation by ultraviolet light to reduce organics. While apparently effective, this treatment is relatively expensive and such devices restrict total water output.

Presently, there does not appear to be any system or method for filtering water to the extent that such water is able to evaporate from the cleaned surface so that the surface does not contain any remaining film or residue.

In addition, there is at present a great need to provide for drinking water purification systems. Presently, a commercially available, stand alone or in-line water purification system that provides a high level of purity of drinking water for consumers does not appear to be readily available.

Further, emergency desalinization systems for use on boats and other water craft are not readily available or known. Such a system may be used in emergencies, for example, where a ship's drinking water supply has been contaminated or depleted and drinking water is needed to survive until the ship's passengers and crew are rescued. In such a case, no readily available commercial system presently is known that provides a portable desalinization system where a significant volume of sea water may be filtered through the system and then used safely for drinking by the ship's occupants.

### SUMMARY

A water filtration system and device is herein disclosed and described that effectively treats water such that the water evaporates with virtually no film, reside, or spots. In one aspect, a water filtration system and device is herein disclosed and described that provides a high level of purity in an in-line or portable water filtration system.

In another aspect, a water desalinization system and device for use in emergency situations where sea water (or brackish water) is treated and safely provided to be consumed by the ship's occupants is herein disclosed and described.

In yet another aspect, a system and method for treating water in a dwelling is herein disclosed and described that effectively treats the supply-water such that contaminates are removed or reduced and then provides improved palatability to the water prior to its dispensing for consumption.

Thus, in a first embodiment, a device for treating water is provided. The device comprises a housing comprising an inlet for receiving a volume of water; and an outlet for discharging the volume of water. A first filter media, positioned within the housing, comprises an acidic cation exchange resin capable of exchanging at least a portion of metal cations in the volume of water with non-metal cations such that the volume of water exiting the first filter media is reduced in metal cation content. A second filter media, positioned within the housing, comprises a weakly basic anion exchange resin capable of exchanging at least a portion of the basic anions in the volume of water. The first filter media or the second filter media are optionally mixed with a particulate activated carbon. In an aspect of the first embodiment, the second filter media receives the volume of water after exiting the first filter media.

In combination with any of the aspects of the first embodiment, the device further comprises at least one water-permeable casing separately containing the first filter media or the second filter media.

In combination with any of the aspects of the first embodiment, the acidic cationic exchange resin is selected from the group consisting of crosslinked polystyrenes functionalized with sulphonic acid groups.

In combination with any of the aspects of the first embodiment, the weakly basic anionic resin is selected from the group consisting of crosslinked polystyrenes functionalized with tertiary amine.

In combination with any of the previous aspects of the first embodiment, the device comprises about 60-90 volume % acidic cation in combination with about 40-10 volume % weakly basic anion resin, optionally with about 5-10% activated carbon.

In combination with any of the aspects of the first embodiment, the device further comprises at least one unit in fluid communication with the housing, the at least one unit adapted to receive the volume of water prior to contact with the first filter media. The at least one unit comprises a particulate filter media capable of reducing the level of particulates in the volume of water; and a redox filter media capable of chemically reducing or chemically oxidizing at least one component in the volume of water.

In combination with the previous aspect of the first embodiment, the particulate filter media is silica having a bulk density of about 24-26 pounds per cubic foot, and a density of about 2.25 grams per cubic centimeter.

In combination with the previous aspects of the first embodiment, the redox filter media is a copper-zinc alloy.

In combination with any of the aspects of the first embodiment, the device of any of the preceding claims, further comprising a third filter media comprising a carbonate salt of calcium, wherein the third fluid media receives the volume of water after exiting the second filter media.

The use of the device is provided for drinking water for a dwelling, for spotless washing, or for desalinating water.

In a second embodiment, a method of treating water is provided. The method comprises the steps of (i) contacting a volume of water with a first filter media optionally mixed with activated carbon, wherein at least a portion of metal cations present in the volume of water are exchanged with non-metal cations in the first filter media such that the volume of water exiting the first filter media is reduced in metal cation content; and (ii) contacting the volume of water with a second filter media comprising a weakly basic anion exchange resin optionally mixed with activated carbon, wherein at least a portion of anions present in the volume of water are exchanged with anions of the second filter media, the first and second filter media being in fluid communication with each other. The volume of water provided by the method evaporates without leaving a visible residue.

In combination with any of the aspects of the second embodiment, the volume of water exits the first filter media before contacting the second filter media, where the volume of water exiting the second filter media is reduced in metal cations and halogen anions such that the volume of water evaporates essentially spotless.

In combination with any of the aspects of the second embodiment, the method further comprising contacting the volume of water after contacting the second filter media with a carbonate salt of calcium, where at least a portion of the volume of water is increased in the amount of calcium cation, whereby the palatability of the volume of water is improved.

In combination with any of the aspects of the second embodiment, the first filter media is an acidic cationic exchange resin selected from the group consisting of crosslinked polystyrenes functionalized with sulphonic acid groups, the first filter media exchanging at least some protons with the metal cations of the volume of water. The second filter media is a weakly basic anionic resin selected from the group consisting of crosslinked polystyrenes functionalized with tertiary amine, the second filter media exchanging at least some hydroxide ions with the halogen anions of the volume of water.

In yet another embodiment, a supply water treatment system is provided comprising a Point of Entry unit fluidically coupled to a Point of Use unit. The Point of Entry unit is fluidically coupled to a dwelling's supply water and comprises a particulate filter media capable of reducing the level of particulates in the volume of water; and a redox filter media capable of chemically reducing or chemically oxidizing at least one component in the volume of water. The Point of Use system comprises a first filter media comprising an acidic cation exchange resin capable of exchanging at least a portion of metal cations in the volume of water with non-metal cations such that the volume of water exiting the first filter media is reduced in metal cation content, and a second filter media comprising a weakly basic anion exchange resin capable of exchanging at least a portion of the basic anions in the volume of water. The first filter media or the second filter media are optionally mixed with a particulate activated carbon.

Features and advantages of the present invention will become more apparent in light of the following detailed description of some embodiments thereof, as illustrated in the accompanying figures. As will be realized, the invention is capable of modifications in various respects, all without departing from the spirit and scope of the invention. Accordingly, the drawings and the description are to be regarded as illustrative, and not as restrictive in nature.

### BRIEF DESCRIPTION OF THE DRAWINGS

The invention will now be described with reference to the accompanying drawings which illustrate disclosed embodiments of the ratcheting tool of the present invention falling within the scope of the appended claims.

FIG. 1 is a perspective view of a first embodiment of the present invention.

FIG. 2 is a front view of the embodiment of FIG. 1.

FIG. 3 is a side view of the embodiment of FIG. 1.

FIG. 4A is an enlarged perspective view of FIG. 1 with the lid removed.

FIG. 4B is a sectional enlarged view of the lid and collar of FIG. 1.

FIG. 5 is an enlarged perspective view of the top portion of FIG. 1.

FIG. 6 is a perspective view of the underside of the lid of FIG. 1.

FIG. 7 is a sectional view of the top portion of FIG. 3.

FIG. 8 is a sectional view of the bottom portion of FIG. 3.

FIG. 9 is a top view of the base of FIG. 1.

FIG. 10 is a diagrammatic depiction of the operation of FIG. 1.

FIG. 11 is a sectional view of a second embodiment of the present invention representing a point of entry device.

FIG. 12 is a perspective view of a base for the embodiment of FIG. 11.

FIG. 13 is a partial sectional view of the base of FIG. 12.

FIG. 14 is a plan view of a canister of the embodiment of FIG. 11.

FIG. 15 is a perspective view of a cover for the canister of FIG. 14.

FIG. 16 is an exploded view of the embodiment of FIG. 11.

FIG. 17 is a first point of use device aspect of the second embodiment.

FIG. 18 is a second point of use device aspect of the second embodiment.

FIG. 19 is an exploded view of the embodiment of FIG. 1.

FIG. 20 is a graphical representation of Total Dissolved Solids (TDS) data for aspects of the embodiment of FIG. 1.

FIG. 21 is a graphical representation of TDS data for aspects of the embodiment of FIG. 1.

FIG. 22 is a graphical representation of TDS data for aspects of the embodiment of FIG. 1.

FIG. 23 is a graphical representation of TDS data for aspects of the embodiment of FIG. 1.

FIG. 24 is a graphical representation of TDS data for aspects of the embodiment of FIG. 1 verses comparative data.

FIG. 25 is a graphical representation of TDS data for aspects of the embodiment of FIG. 1 verses a control device.

### DESCRIPTION

A device for treating water is provided. The device generally comprises a housing having an inlet for receiving a volume of supply water; and an outlet for discharging a volume of exiting water. The volume of water enters the housing through the inlet and is urged into contact with a first filter media. The first filter media comprises an acidic cation exchange resin where the first filter media is capable of exchanging at least a portion of metal cations in the volume of water with non-metal cations such that the volume of water exiting the first filter media is reduced in metal cation content. Suitable acidic cationic exchange resins may include materials selected from crosslinked polystyrenes functionalized with sulphonic acid groups. Other acidic cation exchange resins may be used provided they are capable of exchanging at least a portion of metal cations in the volume of water with non-metal cations, preferably, hydrogen ions.

The volume of water after having been contacted with the first filter media is urged into contact with a second filter media. The second filter media, positioned within the housing, comprises a weakly basic anion exchange resin capable of exchanging at least a portion of the basic anions in the volume of water. Suitable weakly basic anionic resins may include materials selected from crosslinked polystyrenes functionalized with tertiary amine. Other weakly basic anion exchange resins may be used provided they are capable of exchanging at least a portion of the basic anions in the volume of water, preferably providing hydroxide ion. The first filter media or the second filter media may optionally be mixed with a particulate activated carbon. Multiple layers of the first and second filter media may be arranged within the housing, such that the volume of water is urged into contact with the acidic filter media followed by the weakly basic filter media. This particular arrangement of filter media may be repeated as desired in the housing to achieve the level of water treatment required.

The device is useful for spotless washing as the supply water, upon contact with the filter media arranged as described, is reduced of dissolved or suspended components, which upon evaporation would otherwise remain as a residue, usually a visible residue. Moreover, the device is also useful for desalinating water in an emergency, as the sediments and salts of the otherwise non-potable supply water are reduced or removed to provide potable water.

In a second embodiment, a water treatment system is provided that is adaptable to a dwelling, such as a public, residential, or commercial establishment, building or structure. The system comprises a Point of Entry (POE) unit and optionally at least one auxiliary Point of Use (POU) unit. The POE unit is adapted to receive a volume of water entering the dwelling and is further adapted for fluid communication with the existing water-supply lines of the dwelling. At least one POU units are adapted for fluid communication with the water-supply lines and may be positioned in proximity to typical water dispensing devices, such as spigots, sinks, home appliances, etc. In a preferred aspect, at least one POU unit is adapted for providing water for drinking, cooking, and for servicing a home appliance, such as a refrigerator.

In one aspect of the second embodiment, the water treatment system is designed to receive a volume of water and to cause contact of the water with one or more materials in a sequential or staged manner. In one aspect, the system is adapted to contain materials for treating the water in one or more replaceable containers.

In one aspect, the system removes a portion of heavy metals, metal salts, VOC's, chlorine, pharmaceuticals, pesticides, herbicides, fungicides, sediment, etc., and additionally may “soften” the water. The removal of metals and their salts providing may prevent mineral buildup in equipment associated with the water system of the dwelling, such as water heaters, toilets, appliances, and interior plumbing.

In one aspect of the second embodiment, the device and method of water treatment for a dwelling comprises at least two tanks in fluid communication with each other, each of the tanks comprising one or more filter medias contained in one or more canisters. The bottom of one canister is configured to fluidically engage with the top of another canister. In one aspect, the tanks are fluidically connected in series such that the volume of water and its flow path is at least partially controlled as it migrates through the filter medias.

In another aspect, each of the canisters is configured to be removed and replaced, for example, by the dwelling owner or service provider. Means are provided for rapid replacement of the canisters with minimal or no spillage of the filter media.

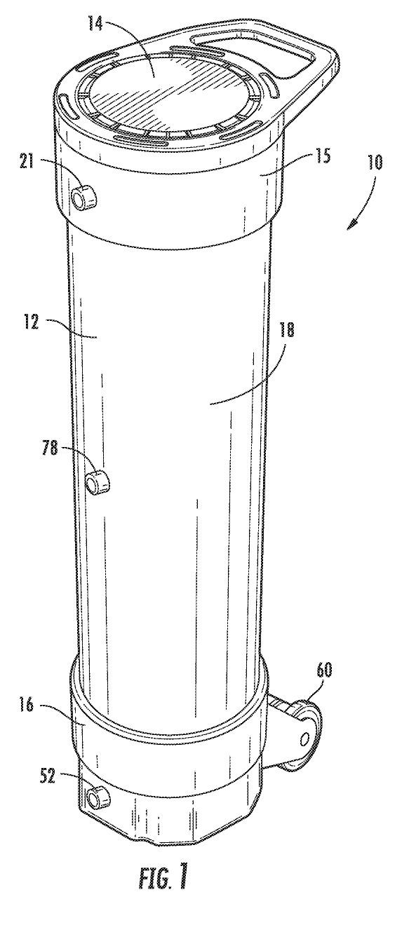

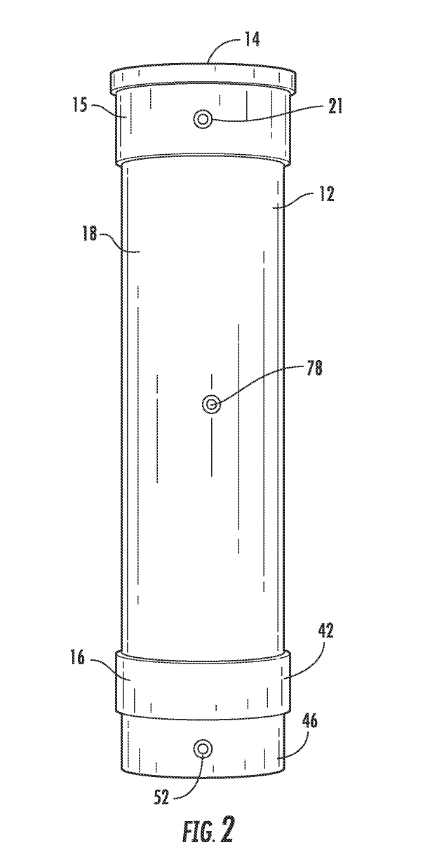

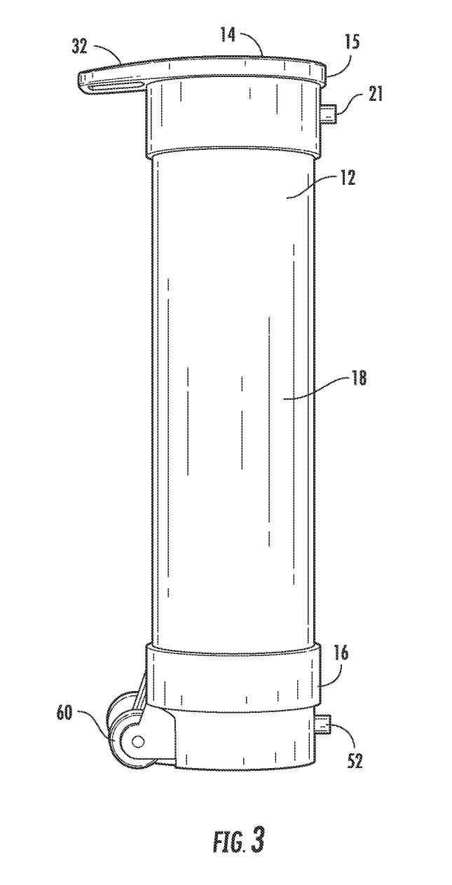

Referring now in more detail to the drawings in which like numbers indicate like parts throughout the several views, FIG. 1 is a perspective view of the water filtration device 10 of the present invention. Shown also in FIGS. 2 and 3, the device 10 includes a cylindrical housing 12 constructed of pipe 18, the housing having lid 14, collar 15, and base 16. In a preferred embodiment, the pipe 18 is made of PVC pipe (e.g., schedule 40, Charlotte Pipe Company), with an exemplary internal pipe dimension of about 8 inches in diameter and 32 inches in length. The base 16 is fixed to pipe 18 by means of a slip fit and fixed with an adhesive such as an epoxy resin. The collar 15 is attached to the pipe in the same fashion. The base 16, collar 15 and lid 14 may all made of molded plastic, preferably injection molded. It should be noted that the length and diameter of pipe may vary so long as the relative volume of the corresponding container, and the filter medias inserted therein, remain proportional, as will be discussed in more detail below.

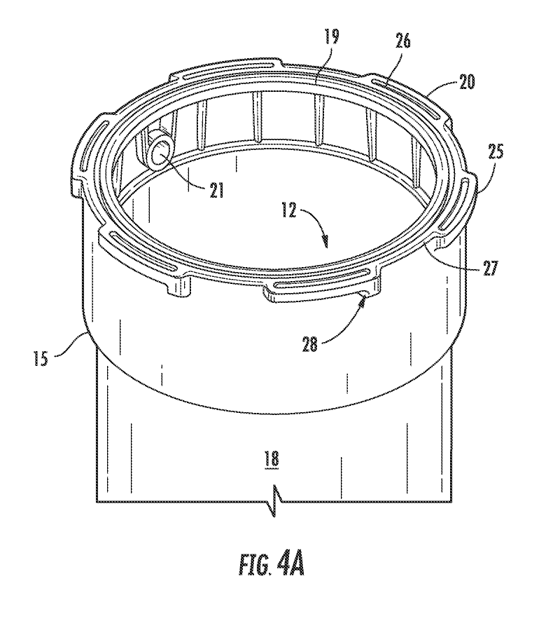

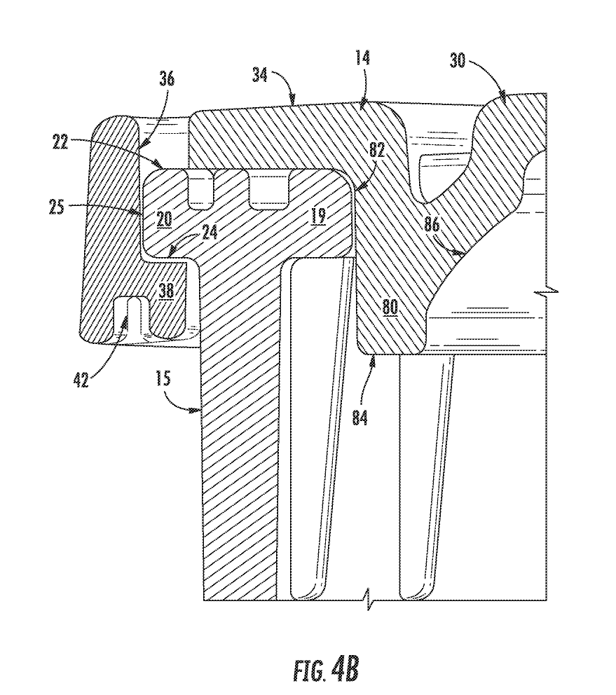

The lid 14 is removable from the collar 15. The collar 15, as shown in more detail in FIGS. 4A and 4B, has a series of spaced apart lips 20 extending radially outward. Each lip 20 has an upper surface 22 and a lower surface 24. Each lip has an exterior surface 25 and an interior surface 27. Each lip 20 also has a stop member 28. The collar 15 also has a water inlet port 21 located on the side of the collar. The inlet port 21 is designed to be matingly fitted to a water supply such as a garden hose. Thus, the inlet port 21 may include internal threads to receive the threaded garden hose connection. The collar 15 also has an inner annular member 19. The annular member 19 interacts with the lid 14 to form a fluid seal when assembled, which will be discussed further below.

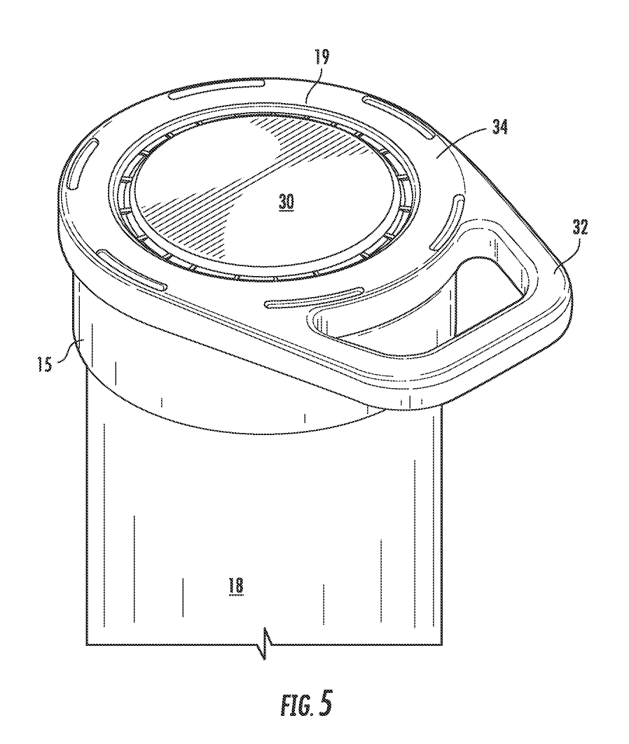

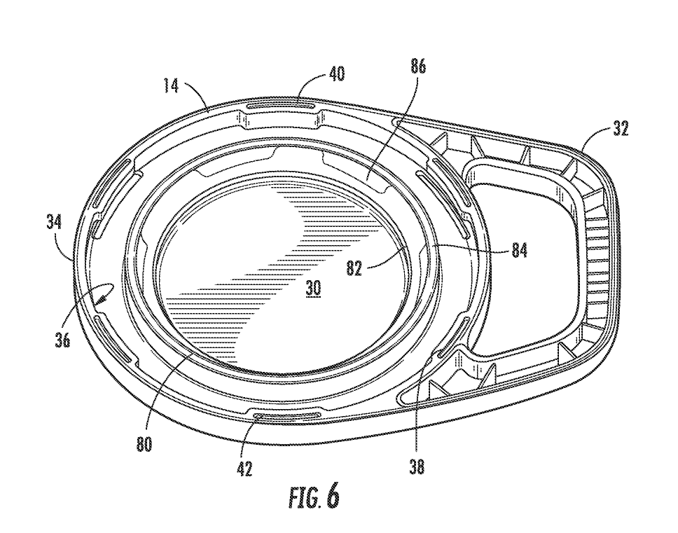

Lid 14, as shown in more detail in FIGS. 5, 6 and 7 has a lid body 30 and a handle 32. The lid body 30 has an exterior surface 34 and an interior surface 36, as shown in FIG. 6. A series of spaced apart ledges 38 extend radially inward from the interior surface 36 of the lid body 30. The ledges 38 are sized and shaped to matingly fit under the outwardly extending lips 20 from the collar 15. Each ledge 38 has a radially interior surface 40. Each ledge 38 has a hollow portion 42 located between the interior surface 36 of the lid body 30 and the interior surface 40 of the ledge.

Lid 14 also has an inner ring 80. Ring 80 has base 82 and tip 84. The inner radial surface 86 of ring 80 is tapered so that base 82 of ring 80 where it is joined to the lid body 30 is thicker than tip 84 of the ring. The ring 80 interacts with the collar 15 in use to form a fluid seal.

The base 16 of the housing 12 is fixed to the pipe 18 by means of a slip fit and adhesive, as shown in FIG. 8. The base 16 includes an upper portion 44 fixed to the pipe 18 and a lower portion 46. The lower portion 46 includes a wheel portion 48, a base body 50 and a water outlet 52. The water outlet 52 is located opposite to the wheel portion 48. The wheel portion 48 includes a rounded area 54, an axel recess 56, an axel 58 and wheels 60. The number of wheels may change, for example, if the wheel size or container size or weight changes. In the present embodiment, the number of wheels is preferably two.

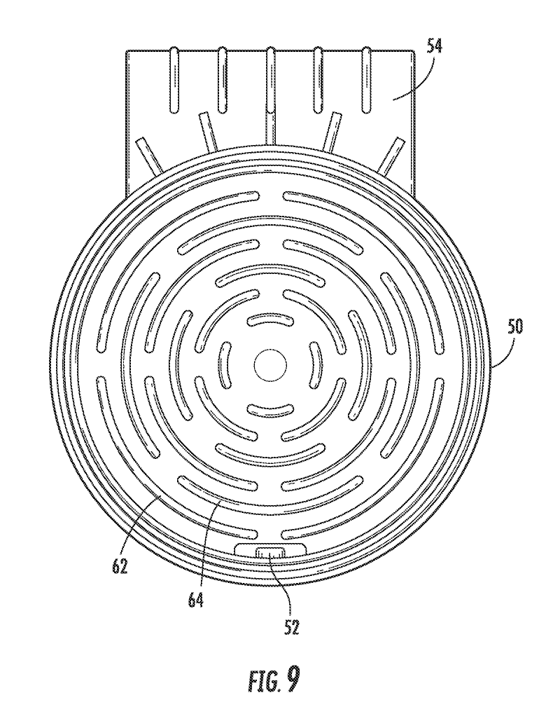

The base body 50 is made up of a base floor 62 and a series of base walls 64 extending upward from the base floor, as shown in FIG. 9. The base walls 64 consist of a series of spaced apart concentric rings with each ring made up of a series of spaced apart arcs of that ring. The spaces in each ring are 90° apart from the spaces in the adjacent rings. The arrangement of the base walls is designed to provide a tortuous pathway for the water as it moves through the housing 12 to the water outlet 52.

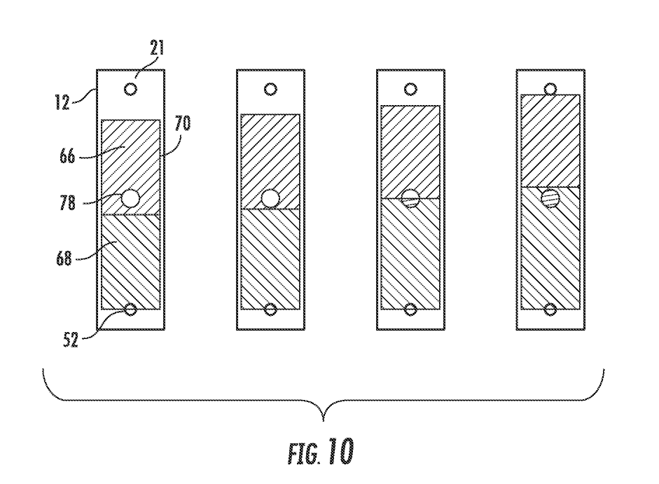

In one aspect, two filter medias are located within the housing 12, as shown in FIG. 10. A second filter media 68 is positioned on the bottom half of the container and a first filter media 66 is positioned on the top half of the container. In one aspect, the first and second filter medias are physically separated from each other. The first filter media 66 is contained in a flexible, water permeable first casing 70. The second filter media may also be contained in a similar casing 70. The casing may be any plastic or non-plastic material provided that the material will contour to the shape of the pipe. The casing preferably has sufficient porosity to water, does not substantially leach or otherwise contaminate the water passing through, and prevents the filter media composition components from leaching or otherwise contaminating the water. For example, the casing may be a microporous, macroporous, woven or nonwoven material. In a preferred embodiment, the casing is a 100% polyester knit. In one aspect, the first casing is a 100% polyester knit manufactured by Carriff Corporation of Midland, N.C., having part no. FA-04356C Blue. The first filter media 66 is prepared by filling casing 70, which is closed at one end, with a first filtration particulate 74 and closing the second end of the casing to form a closed, tube-like container adaptable to the housing. The filter media casing 70 may be closed at both ends using conventional non-corrosive fastening materials such as for example, stainless steel, aluminum alloy or the like. In a preferred embodiment, the clips 72 are an aluminum alloy manufactured by Tipper Tie Inc. of Apex, N.C. (part no. THZ400). The casing may be filled less than completely or is capable of expanding with the filter media upon contact with the supply water.

Likewise a second filter media casing is filled with a second filter media 68. In one aspect, the first filter media composition 66 comprises a mixture of activated carbon and a strongly acidic cation gel ion exchange polymer. The particulate composition of the first filter media may comprises a strong acidic cation gel ion exchange resin, (for example, SST60 manufactured by Purolite), the remainder being activated carbon. The resin and carbon may be randomly dispersed therein or they may be layered. In a preferred aspect, the carbon is randomly dispersed in the acidic resin by mixing or commutating.

The second filter media 68 is prepared in a similar manner to that of the first filter media, and may be made of the same or similar casing. In a preferred embodiment, the second filter media casing is also 100% polyester knit, (Carriff Corporation, part no. FA-04355C Red). The casing for the second filter media 68 holds a second filtration particulate composition 76. In one aspect, the second filtration particulate composition 76 comprises a mixture of activated carbon and a weak base anion macroporous ion exchange resin. For example, an exemplary second filtration particulate mixture comprises 5% by volume activated carbon and 25% by volume weakly base anion macroporous ion exchange resin. In a preferred aspect, the weakly basic resin is a crosslinked polystyrene resin having tertiary amine functional groups, for example, A113S manufactured by Purolite, and the activated carbon is coconut shell-derived, for example, 1230 cc manufactured by United States Resin Company.

In the event that the supply water is intended for drinking, the relative proportions of cation and anion resins, and carbon may be varied. For example, for treating supply water for drinking, the relative volume proportions of cation resin and the basic anion resin with carbon may be approximately 40%, 55% and 5% respectively.

The overall interior volume of a container may be measured, and a margin of 20% of the measure volume may be deducted to allow for later expansion of the filter media and the corresponding casing. In one aspect, at least a portion of the remaining 80% volume of the container after the margin of 20% is determined is occupied by the second filter media. Thus, for example, 60% of the remaining volume, or 48% of the total volume, may be occupied by the first filter media, and a corresponding 40% of the remaining volume, or 32% of the total volume, may be occupied by the second filter media. The volume % range of the acidic cation and anion resins and carbon may be between 60-90%, 40-10% and 5%, respectively, with a margin of ±5% when treating water for cleaning purposes. In one preferred aspect, the acidic cation resin filter media casing is devoid of carbon and the basic anion resin filter media includes carbon. Thus, the ratio of cation resin, anion resin with carbon may be 60%, 40% and 5% respectively; 70%, 25% and 5% respectively; 80%, 20% and 5% respectively; or 90%, 10% and 5% respectively, with a margin of ±5%, with the carbon mixed with the basic anion resin in the second filter media. In a preferred aspect, the ratio of cation resin, anion resin with carbon is preferably 70%, 25% and 5% respectively, with the carbon mixed with the basic anion resin in the second filter media. These ratios are observed to provide acceptable surface cleaning and spot-free drying for a wide range of supply water.

As a result of the supply water contacting the filter media, one or both of the filter medias may be altered in terms of their relative volume. The resin may expand until its activity is diminished. Thus, the device disclosed and described herein is adapted to exploit this feature in its design and for providing user-indication of the replacement interval.

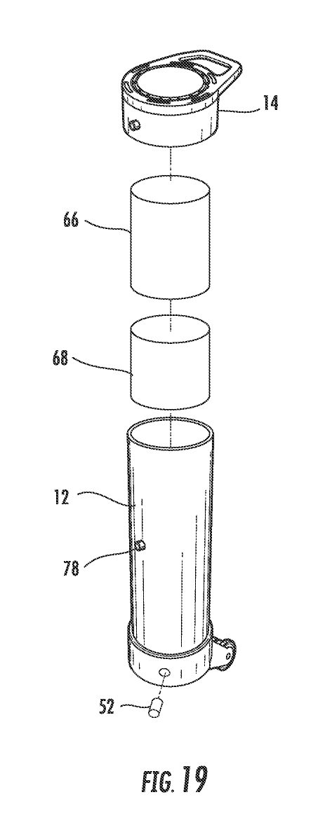

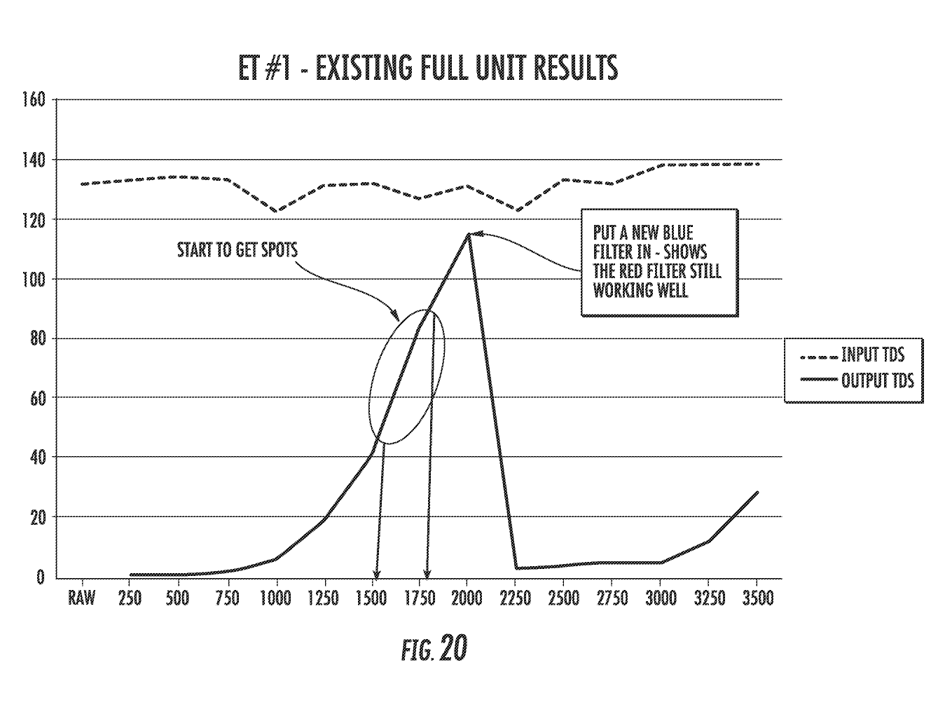

Referring to FIG. 19, to assemble the mobile device, the casing comprising the second filter media 68 is inserted into the housing 12 in proximity to the supply water inlet. The casing with second filter media is inserted so that one end of the filter media sits on the base floor 67 and the other end of the second filter media is located approximately halfway along the height of the housing 12. The casing comprising the first filter media 66 is then inserted into the housing 12 and is positioned adjacent the top of the casing with the second filter media 68. In this aspect, the first and second casings are physically separated. In one aspect, using a device with a diameter of 20.5 inches and an internal container depth of about 32 inches, the top of the casing with second filter media 68 preferably be located about 2.5 inches below the indicator window when the casing is fully inserted into the container, for example, to allow for the expansion thereof. When the housing 12 is assembled, the first filter media 66, preferably having a colored casing, is positioned adjacent to the indicator window 78. In one aspect, casing 70 of the first filter media 66 is blue, or another bright color which will be visible to the user through window 78, with the second casing being red. Other color combinations may be used.

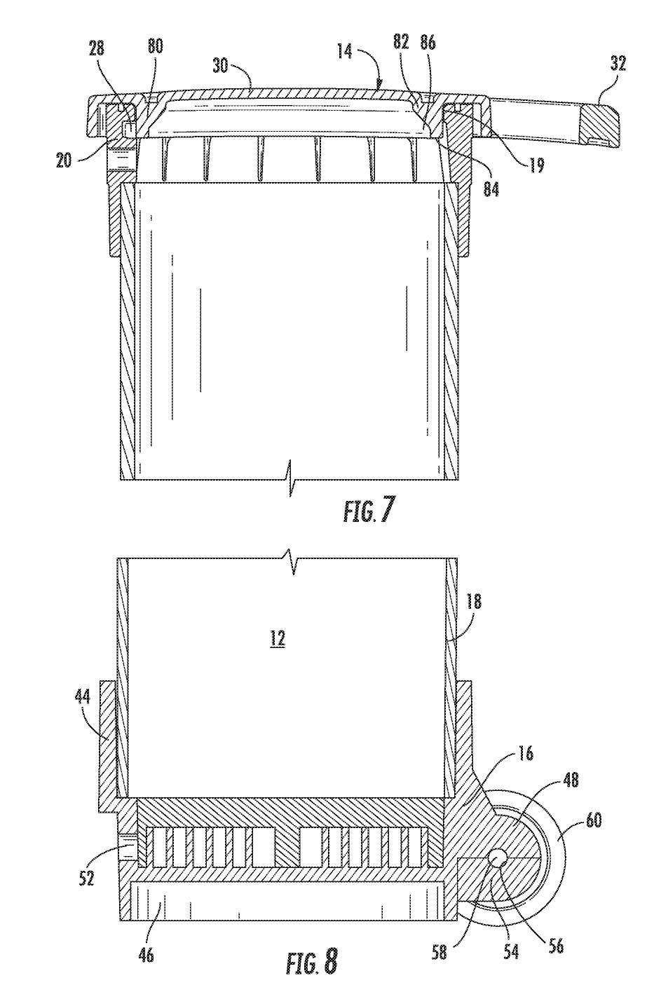

Once both filter medias and casings are inserted into the housing 12 the lid 14 may be secured to the collar 15. This is done by placing the lid 14 over the collar 15. The lid 14 is positioned relative to the collar 15 so that the collar lips 20 and the lid ledges 38 are spaced apart. The lid 14 is then rotated by the user at the handle 32 in a counterclockwise direction so as to rotate the ledges 38 underneath the collar lips 20. As the lid 14 is rotated, each ledge 38 moves underneath a corresponding lip 20 until the ledge meets the stop member 28 of the corresponding lip 20, as shown in FIG. 7. When the ledge 38 meets the stop member 28, the stop member ends the rotational travel of the lid 14 and each ledge 38, securing the lid to the container providing essentially a water-tight seal.

The fully assembled device is then connected to a supply water source via inlet 21, for example, a garden hose which is threaded to the water inlet 21. In use, the supply water passes through the water inlet 21 and into the housing 12. As the water enters the housing 12, the water contacts first filter media 66 housed within the casing 70. The first filtration media interacts with the water to bond or otherwise reduce or remove various compounds present in the supply water. While not being held to any particular theory, it is believed that many minerals typically present in most water supplies have a positive charge associated to them. These positively charged contaminates may become electrostatically attracted to certain electrolytic compounds in the first filter media and are thus removed or reduced from the water, at least a portion of the mineral cations being exchanged for non-metallic cations, preferably protons. As a result, as the water exits the first filter media, many of the positively charged contaminates, such as metallic or mineral cation contaminates originally present in the supply water, are removed or reduced, and remain within the first filtration particulate mixture. As the first filter media is acidic, it is likely that the overall pH of the water as it exits the first filter media may be acidic (e.g., pH range of less than 7) or in any event, more acidic than the supply water. In use, the pH of the water exiting the first filter media casing may range from 3-6 depending on the level of exhaustion of the acidic cation resin.

Subsequently, the water that has exited the first filter media 66 then passes through the second filter media 68. As it passes through the second filter media 68, which interacts with certain other contaminates in the supply water so as to remove or reduce at least a portion of these contaminates, preferably contaminates having associated therewith a negative charge, such as for example, chloride and other halogen ions. In addition to halogen ions, silicas, bicarbonates and other weak acids may be substantially removed or reduced from the water during contact with the second filter media 68. As the second filter media 68 is primarily basic in its pH, the water exiting the first filter media 66 and contacting the second filter media is substantially neutralized, typically providing exiting water with a pH between 6 and 6.8.

In a preferred aspect, the device is configured such that the supply water substantially first contacts the acidic cationic resin and then contacts the supply water contacts the weakly basic anion resin. The pH level of the water exiting the acidic cation resin in the first filter media 66 will likely be between 3-6. The basic anion resin in the second filter media 68 will likely add hydroxide to the free hydrogen from the acidic cation resin in the first filter media 66 and combine to form water. This reaction results in adjusting the pH of the exiting water (for example, to a slightly acid, neutral level, around between 6 and 6.8).

Once the water has passed through the second filter media 68 it moves through the tortuous pathway formed by the base walls 64 and out through the water outlet 52. The water may be used as drinking water or applied to cleaning surfaces, such as cars or boats. In this use, the quality of the water is such that the discharged water will evaporate from the cleaned surface and leave substantially no residue or spots.

The present system and method are focused, in part, on treating water that will not leave any spots or residue when it evaporates on a particular surface. For this reason, small amounts of neutrals and gases may remain in the exiting water as they generally do not impact on spotting.

A diagrammatic depiction of the process of treating supply water as herein disclosed and described is depicted schematically in FIG. 10. The size of the first filter media 66 and second filter medias 68 are calculated to allow for expansion of the filter media volume over time relative to the total container volume and indicator window location. Over time and with use, the second filter media 68 increases in volume as it interacts with certain compounds in the water. Similarly, over time and with use, the first filter media 66 decreases in volume. As this process occurs, the second filter media moves upward in position within the housing 12. As the second filter media 68 reaches its maximum volume and the first filter media 66 decreases in volume, the second filter media moves into view of the indicator window 78. Because the first filter media casing is preferably a different color from the second filter media casing, this changes the color of the indicator window from the first filter media color (for example, blue) to the second filter media color (for example, red). This provides a clear visual indication to the user that it is time to replace the filter medias. Other colors or symbols may be used to indicate to a user that the filter medias need to be inspected or replaced. It should be noted that an alternative indication system could include a TDS (total dissolved solids) alarm system. These are known in the art and provide an audio and/or visual indicator to the system user that the TDS in one or both filter medias has reached a preset level. The user may also, alone or in combination with TDS or the indicator window, test the exiting water's pH to determine whether one or both filter medias need replacement.

Without being held to any particular theory, it is believed that the activated carbon present in the filter media helps to remove or reduce undesirable properties of the supply water, such as odor and taste, as well as removing or reducing the level of mineral salts, chlorines and other components that would otherwise leave a residue upon evaporation of the water. The use of admixed activated carbon may also help to extend the life of the resin media. In one aspect, the coconut shell activated carbon disclosed herein is preferred as providing a greater surface area for reacting with the incoming water than other activated carbons.

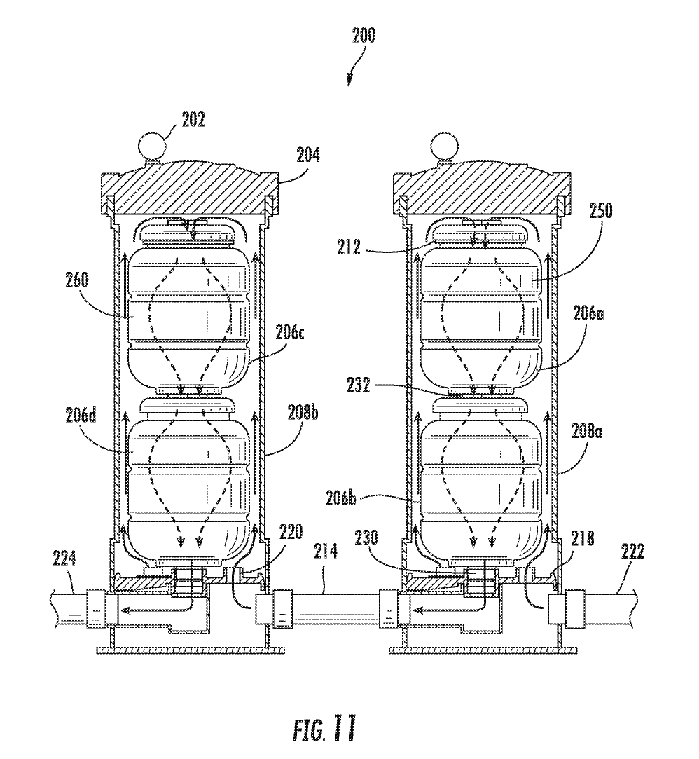

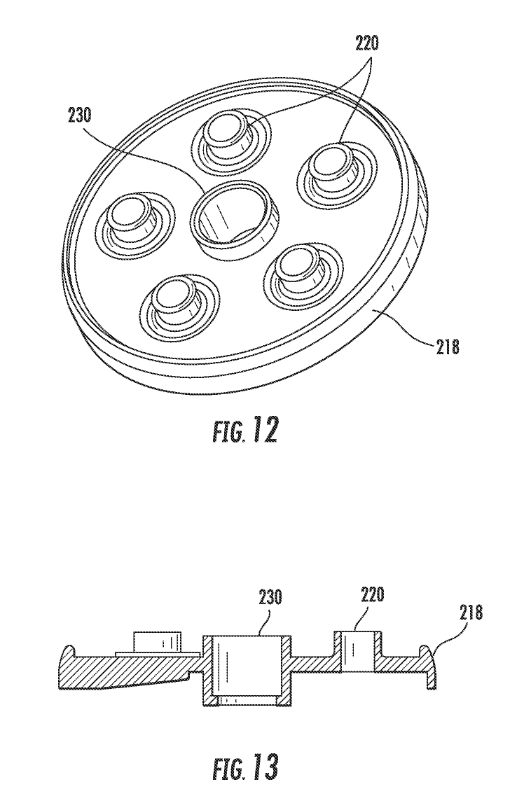

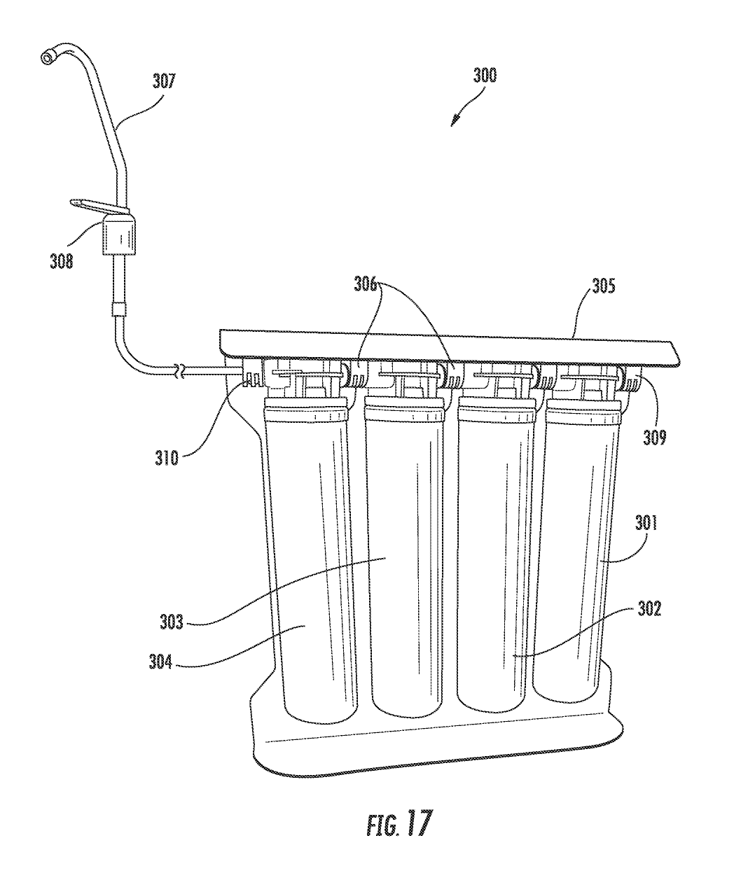

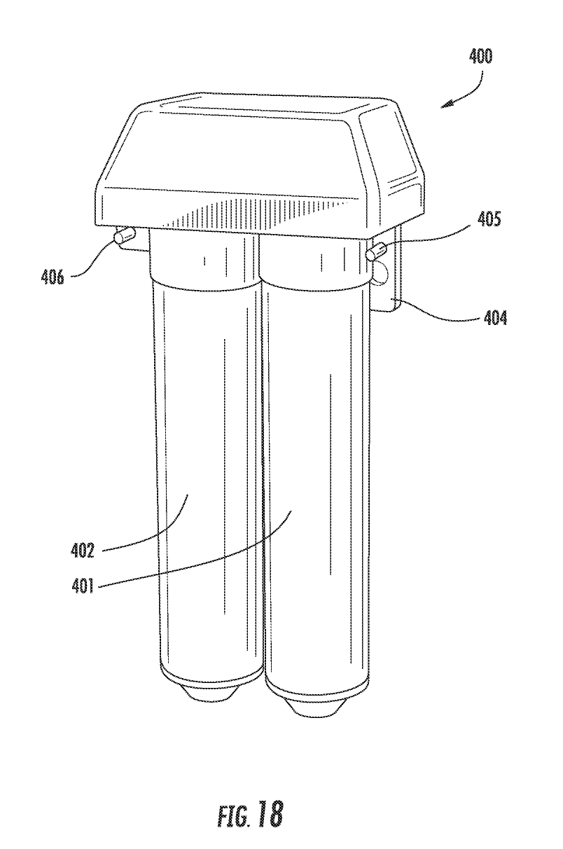

In the second embodiment and by way of example illustrated by FIGS. 11-18, a treatment water system 200 comprising a Point of Entry component and a Point of Use component and a method of treating a volume of water for a dwelling is now described. Thus, a volume of water enters the dwelling from a well or municipality under a pressure and at a flow rate enters a first tank 208a of system 200 at an inlet 222 located near the bottom of the tank. The water is urged through first orifices 220 of base plate 218 from the bottom inlet up the inside of the first tank and then is urged downward under lid 204 (as indicated by the arrows) through a first canister 206a positioned in the tank. Lid 204 may be fitted with a pressure gauge 202 fastened to lid by connector 202a.

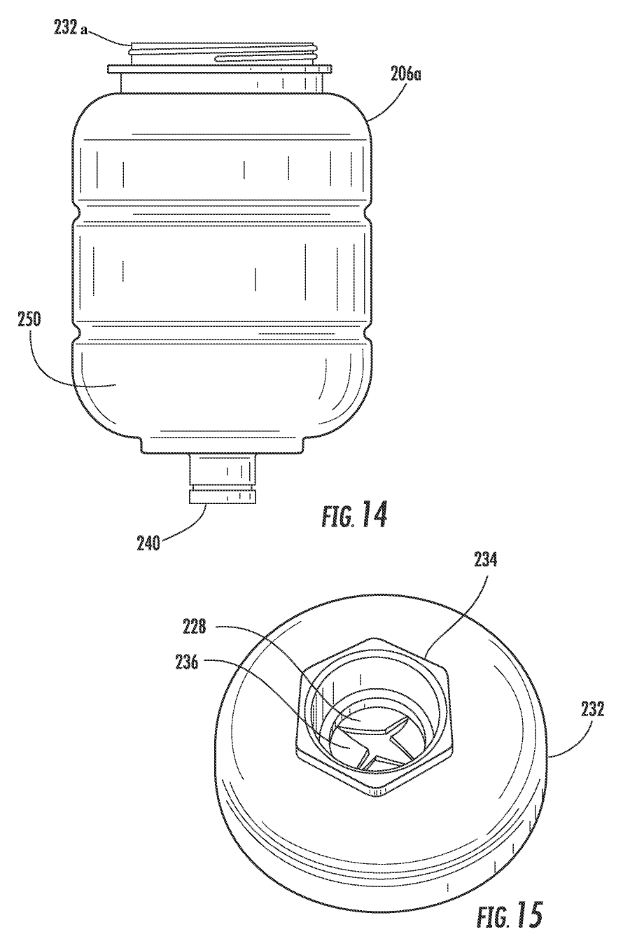

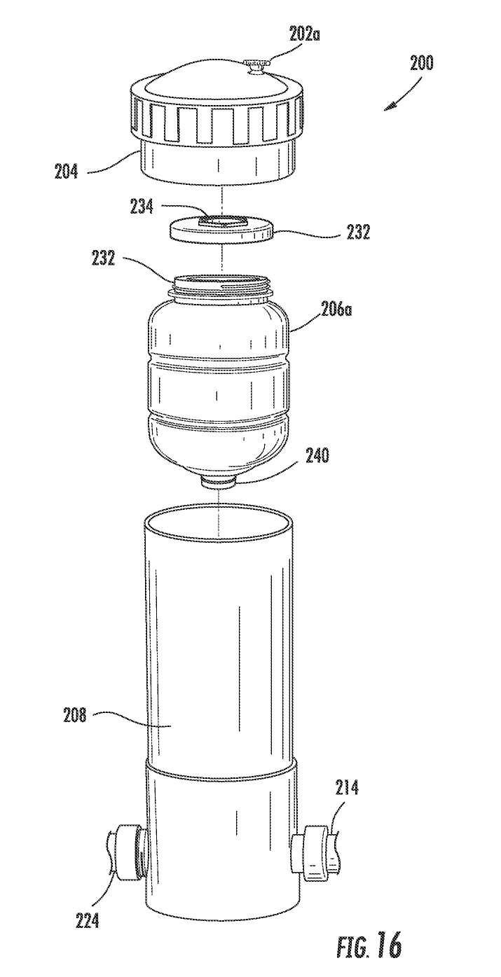

The first canister 206a comprises treaded opening 232 at one end, and nipple 240 at the opposite end, as shown in FIG. 14. Treaded opening engages lid 232, which comprises tightening means 234 having opening 236 for receiving nipple 240 of another canister when arranged in a stacked configuration. Closing means 228 comprising a cross-slit elastomeric seal may be provided to self-close the lid during replacement. A first filter media 250 for the removal or reduction of at least part of the sediment present in the volume of water is provided in canister 206a. This provides at least some protection of the subsequent filter media in the water's flow path from fouling or other processes that otherwise would diminish the water flow or diminish the effectiveness of the system. In this aspect, it is desirable for the first material to remove a substantial amount of impurities present in the water, such as oxidized iron (Fe+2/Fe+3) salts and other colloidal matter that is not in solution with, but may be otherwise carried along with the in coming water. In one aspect, filter media 250 in the first canister may comprise a silica compound of high surface area. For example, Filter Media AG (Clack Corp.), which is a silica material with high surface area, may be used. Other materials possessing high surface area and an affinity for rapidly and efficiently attracting and holding sediments and iron salts may be used or may be used in combination with the Filter Media AG.

Upon exiting first canister 206a, the volume of water may then urged into an optional second canister 206b in first tank 208a. The second canister is in fluidic communication with the first canister via lid 232 such that the first and second canisters are arranged in series. Second canister 206b may comprise the same filter media 250 as the first canister, such as Filter media AG, or optionally may also comprise a bed of crushed calcium carbonate, for example, should the volume of water have a low pH. It is generally believed that in this arrangement of the first and second canisters there is substantial removal of the aforementioned sediments and iron salts in the volume of water prior to contact with the subsequent downstream filter media of the system. For example, as will become apparent in the disclosure below, dirt, silt, and oxidized iron will likely have a detrimental effect on the ability of the filter media in subsequent canisters, and should otherwise be avoided.

Upon exiting the second canister via second orifice 230 of base plate 218, the volume of water is then urged into a second tank 208b via conduit 214, second tank 208b comprising a third and optionally a fourth canister (206c, 206d). The third canister 206c is in fluidic communication with the fourth canister 206d such that the third and fourth canisters are arranged in series. Third canister 208c comprises filter media 260 comprising finely granulated material capable of oxidizing and reducing contaminates in the water (a redox media) together with granular activated carbon (GAC). The redox media may comprise finely granulated copper and zinc alloys. Suitable alloys include, for example, KDF 55 or KDF 85 (Fluid Treatment, Inc.). The redox media and GAC may be mixed in any proportions suitable for effective and efficient removal of the contaminates in the volume of water. Thus, in one aspect, the volume ratio of the material of the third canister comprises about 50% KDF 55 (or KDF 85) and 50% GAC. The GAC preferably is an arsenic free carbon, or one that is not from a coal source. The particular KDF may be chosen based on the source of the volume of water. For example, if the volume of water is provided by a municipality, KDF 55 may be used such that effective and efficient conversion of chlorine to chloride ion may be achieved, which when further contacted with the weakly basic filter media of the POU component of the system would be at least partially exchanged for another ion as previously described. If the volume of water is supplied by a well, for example, then a mixture of 50% KDF 85 and 50% GAC may be used, such that ferrous salts and hydrogen sulfide may be effectively and efficiently removed or reduced. In one aspect, the KDF Filter Media is used in a layered arrangement. In another aspect, to get the amount of through flow and the most amounts of usable gallons through the filter media, it is preferred to mix the KDF and GAC together in about a 50% to 50% ratio by volume.

Upon exiting the third canister 206c, the volume of water is then urged into the optional fourth canister 206d in the second tank. The third and fourth canisters may be stacked upon each other as described above and configured to urge the volume of water in a predetermined manner through the system. The fourth canister may comprise generally the same filter media and filter media arrangement as in the third canister. For at least one reason, the third and fourth canisters may comprise the same filter media in the event of a constant or intermittent high flow condition where there may be some leakage or the filter media of the third canister is loosing some of its activity. As the volume of water contacts the filter media of the third and fourth canisters, at least a portion of the contamination present in the volume of water is oxidized and/or reduced upon contact with the redox media. The volume of water exiting the system is thus reduced in metal cation content and halogen anions, providing improved supply water. The volume of water leaving the Point of Entry Unit via conduit 224 may be used through the entire dwelling and can be used as a universal unit for any number of applications. Preferably, the volume of water is sent to at least one POU device as now described.

The POU device is essentially configured as the first embodiment device as previously described. Thus, referring to FIG. 17, POU device 300 generally comprises a housing or series of fluidic communicating housings (301, 302, 303, 304) connected via couplings 306 and assembled in bracket 305, the housings having an inlet 309 for receiving a volume of water and an outlet 310 for discharging the volume of water. The POU device essential comprises the same filter media and is arranged such that the volume of water is urged into contact with the acidic filter media followed by the weakly basic filter media (See, for example, FIG. 19), or individual housings may contain only one of the acidic cation resin or basic anion resin, optionally with activated carbon. Thus, housings 301, 302, nearest inlet 309 may comprise acidic cation resin while housing 303 may contain basic anion resin. Other configurations of resin combinations and arrangements among the housings may be used. Since the POU device is adapted for supplying water for human consumption, the POU device may additionally comprise other filter media to impart a palatable taste to the water. In one aspect, the POU unit comprises a filter media of calcium carbonate for introducing a source of calcium into the water for palatability, for example nearest the outlet 310, contained in housing 304. Other substances may be introduced into the volume of water exiting the POU device, such as vitamins, pharmaceuticals, etc. Exiting water may be sent to faucet 307 and dispensed via spigot 308. Similarly, referring to FIG. 18, POU unit 400 having inlet 404 providing a volume of water to housings 401 and 402, with outlet 406, may be adapted to service a home appliance such as a refrigerator or washing machine or dishwasher. POU 400 may be of a smaller size for convenient mounting near the appliance using bracket 404.

### Examples

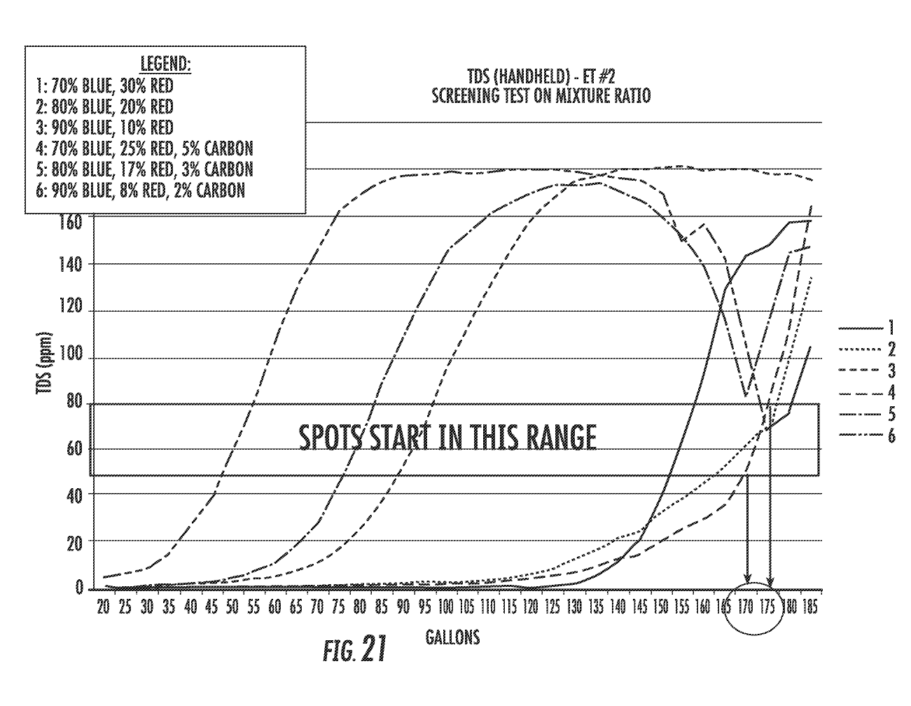

FIG. 20 shows the performance of a 57% acidic cation polymer resin/43% activated carbon and 43%/57% anion resin filter media combination, respectively, each media separated in its own casing, used for treating supply water. As the supply water passed through the filter media composition of this system TDS (total dissolved solids) were measured at fixed intervals relative to the flow in gallons. As can be seen in FIG. 20, as the TDS in ppm on the vertical bar relative to the total flow of treated water in gallons began to increase and the pH level began to increase as well, indicating a decrease in the effectiveness of the acidic cation filter media. At particular intervals the pH and spotting were also measured. The spotting was measured using polished mirrors contacted with exiting water, which was allowed to dry. Spots on the mirrors were assessed visually. As indicated in FIG. 20, spotting began to occur after approximately 1500-1750 gallons passed through the system. As a result, new acid cation filter media was installed and the TDS, as well as the pH, decreased as indicated. It was generally observed that if the pH of the exiting water remained slightly acid or neutral and only the TDS increased, both filter medias likely needed replacement. Furthermore, it was generally observed that if pH of the exiting water decreased (became acid) while the TDS increased, anion filter media likely needed replacement.

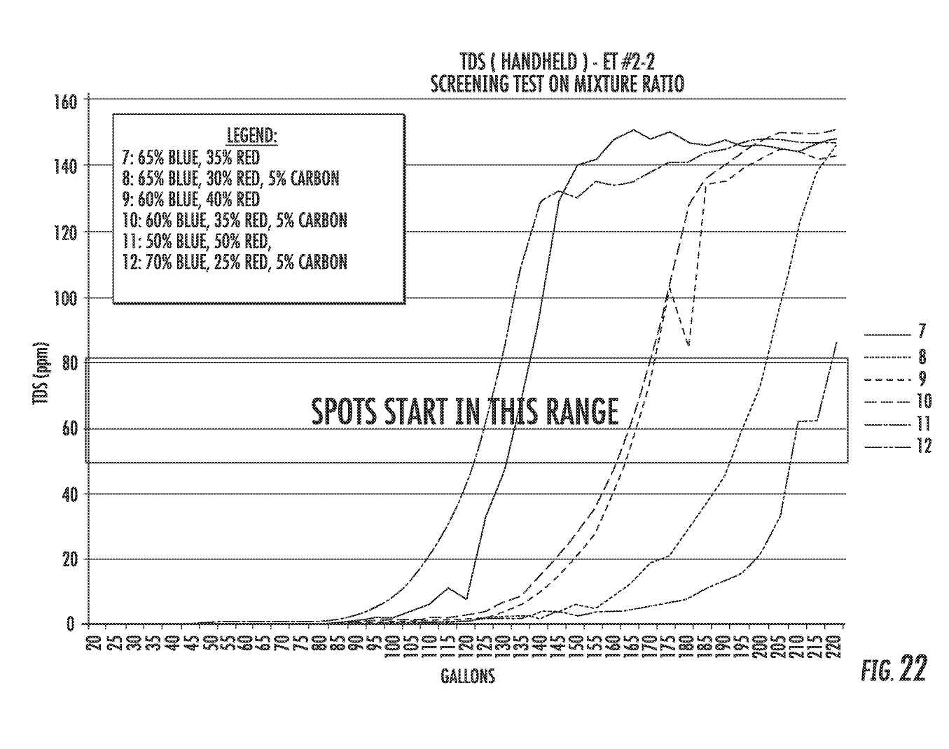

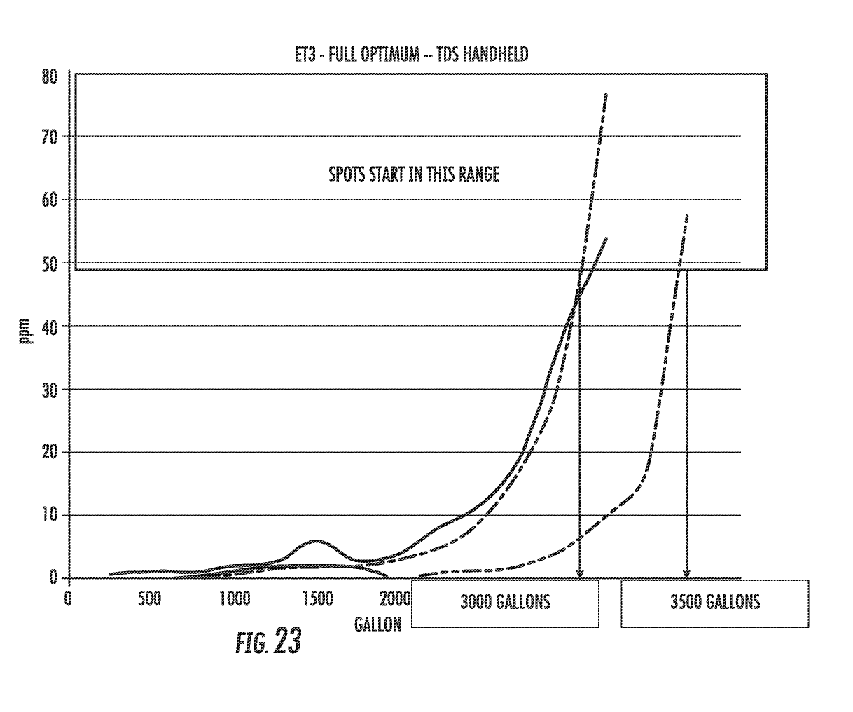

FIGS. 21-22 depict the results of testing conducted using various combinations of filter media compositions and volume ratios of acidic/basic resins as to TDS and spotting. Thus, eleven (11) different filtration media combinations were formulated and tested. Each volume of anion resin and carbon (where applicable) were mixed and inserted into a testing tank that simulated the mobile unit of FIG. 1, and thus can be approximated to represent a small scale version of the full scale model. The testing tank volume was 0.05 cubic feet. The acidic cation resin was added by volume to the tank. The filter media casings as described above were not used, however, both cation and anion mixtures were separately inserted into the testing tank so that the water was exposed first to the acidic cation mixture and then to the weakly basic anion/carbon mixture. Samples 4 and 12 were duplicates of a 70% by volume acidic cation resin, and 25% by volume basic anion resin mixed with 5% activated carbon. TDS measurements in ppm for each filtration mixture relative to total water flow in gallons demonstrated mixtures 4 and 12 provided optimal performance, whereas a range of about 60-80 volume % acidic cation in combination with about 40-20 volume % basic anion resin (with or without up to 10% carbon) provided acceptable performance, for example, equivalent or better than existing systems available commercially.

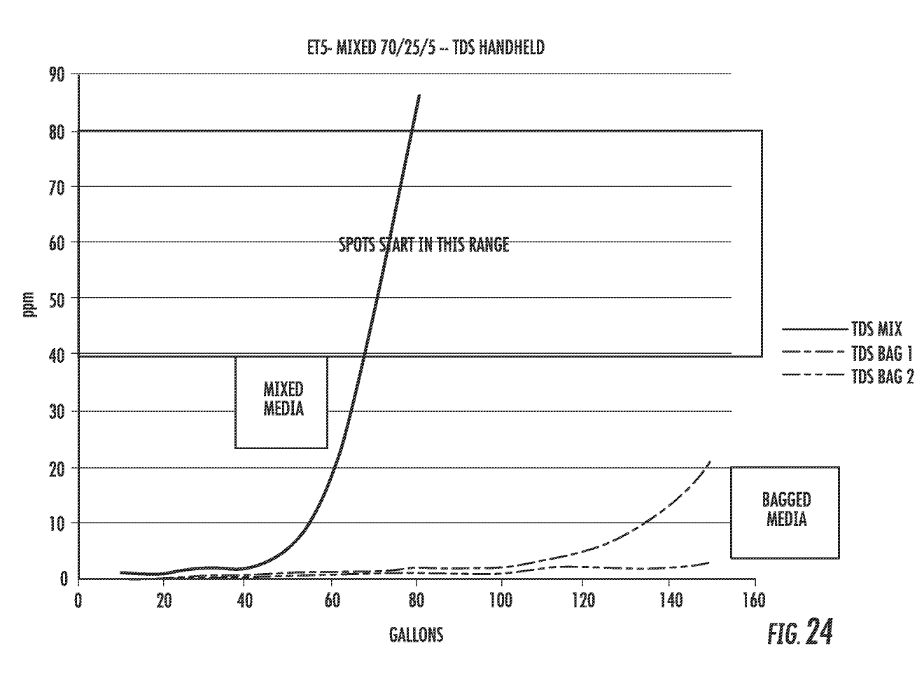

FIG. 23 demonstrates the same filter media combination of sample 4 above provided the equivalent results with the full scale system. The full scale model for this embodiment is 0.84 cubic feet.

### Comparison of Mixed vs Separated Acidic and Basic Resins for Providing Spot-Free Cleaning

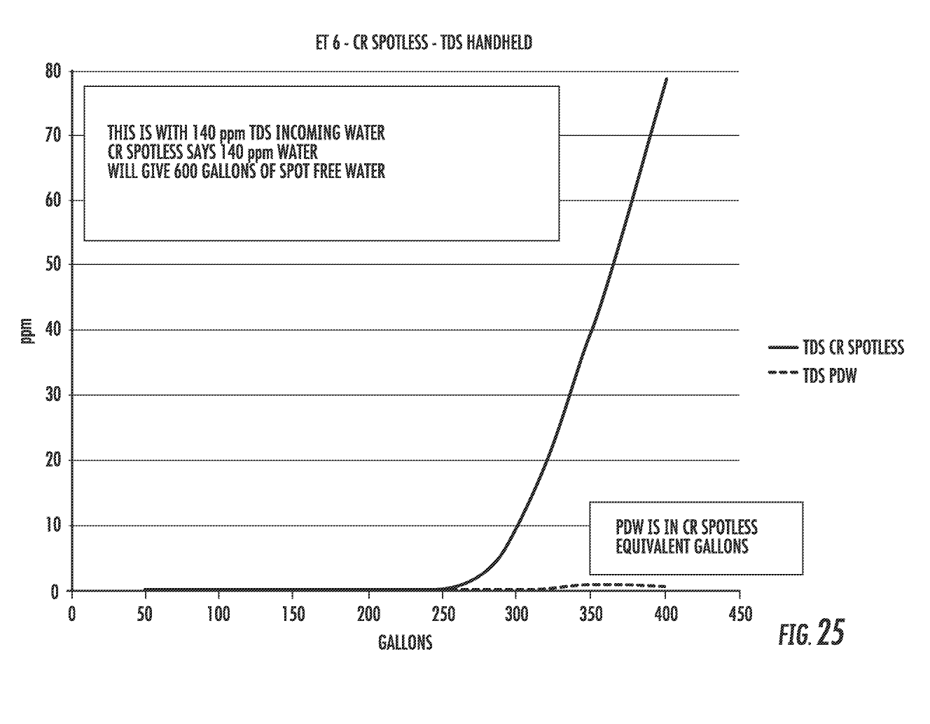

FIG. 24 demonstrates the effect of physically separating the acidic and basic filter media on treating supply water. Thus, a separated filter media combination having as an exemplary composition of filter media of about 70%/25%+5% , cationic resin, weakly basic anionic resin and carbon respectively) was tested against the same volume ratio composition mixed together. As shown in FIG. 24, the spot-free quality of exit water treated using the filer media all mixed together (hereafter referred to as “Mixed Media”) declined and the TDS increased at a rate at least 2× that of the water treated using the preferred embodiment of separated filter media (indicated as “Bagged Media” in FIG. 24). Thus, the physically separated acidic cation/basic anion arrangement provides a greatly improved performance for supply water treatment over the same material volume ratio mixed together. It may be estimated from the data of FIG. 24 that mixing the acidic/basic filter media reduces the total amount of exit water in gallons that can be treated to a spot-free and low TDS level to about ⅔ that of the embodiment herein disclosed and described.

### Comparative Example & Results

A comparative example demonstrating the improved exit water quality achieved using the embodiments described and disclosed with that of a commercially available system water treatment system were performed. Thus, a CR Spotless unit by Spotless Water Systems of San Diego, Calif., which is believed to comprise a mixture of de-ionizing resins, not otherwise separated, including a strongly basic anionic resin, were compared to the system herein disclosed and described. The CR Spotless unit was subjected to the same tests and testing equipment for spotting and TDS in ppm vs. Total Flow in gallons. The comparison data of the two systems are graphically depicted in FIG. 25, which shows the commercially available CR Spotless product performed at a noticeably lower level than the embodiments herein disclosed.

### Desalination of Salt Water

Experiments were preformed using the filter media composition and arrangement as described above for sample 4 using a sample of the Atlantic Ocean as supply water. The quality of the exit water obtained is summarized below. TDS of the exit water was reduced from 35,500 ppm to 364, the palatability of the water was rendered acceptable, and the pH was slightly raised. Thus, for at least certain emergencies of a temporary duration, the system herein disclosed and described may provide for substantial improvement of ocean or brackish supply water suitable for drinking.

As the water supplies both city and rural are being stressed with the growing population, it is desirable for each individual dwelling owner or municipality to ensure the quality of the water consumed by persons from water problems both harmful or of a nuisance.

The water processing system as herein disclosed and described does not require that the user add regenerating chemicals, such as salt to the system. Nor is it necessary to “backwash” or otherwise “regenerate” the system, which provides for improved water conservation. Moreover, because the system does not need electricity, it also provides for energy conservation. The canisters that contain the filter media are designed and configured to be reversibly installed and removed for replacement of the filter media and thus can be reused again and again. The filter materials are generally recyclable as well. Thus, it is generally believed that the environmental impact for the above disclosed water treatment system is minimized, for example, when compared to other types of systems typically used for water treatment of dwellings.

The following claims are in no way intended to limit the scope of the invention to the specific embodiments described. It should be understood by those skilled in the art that the foregoing modifications as well as various other changes, omissions and additions may be made without parting from the spirit and scope of the present invention.

What is claimed is:

1. A device for treating water comprising:
a housing comprising
an inlet for receiving a volume of water; and
an outlet for discharging the volume of water therethrough;
a first filter media, positioned within the housing, the first filter media comprising an acidic cation exchange resin wherein the first filter media is capable of exchanging at least a portion of metal cations in the volume of water with non-metal cations such that the volume of water exiting the first filter media is reduced in metal cation content; and
a second filter media, positioned within the housing, the second filter media comprising a weakly basic anion exchange resin wherein the second filter media is capable of exchanging at least a portion of the basic anions in the volume of water,
wherein the first filter media or the second filter media are optionally mixed with a particulate activated carbon.

2. The device of claim 1, further comprising at least one water-permeable casing for separating the first filter media from the second filter media.

3. The device of claim 1, wherein the acidic cationic exchange resin is selected from the group consisting of crosslinked polystyrenes functionalized with sulphonic acid groups.

4. The device of claim 1, wherein the weakly basic anionic resin is selected from the group consisting of crosslinked polystyrenes functionalized with tertiary amine.

5. The device of claim 1, further comprising at least one unit in fluid communication with the housing, the at least one unit adapted to receive the volume of water prior to contact with the first filter media, the at least one unit comprising:
a particulate filter media capable of reducing the level of particulates in the volume of water; and
a redox filter media capable of chemically reducing or chemically oxidizing at least one component in the volume of water.

6. The device of claim 6, wherein the particulate filter media is a silica having a bulk density of about 24-26 pounds per cubic foot, and a density of about 2.25 grams per cubic centimeter and wherein the redox filter media is a copper-zinc alloy.

7. The device of claim 6, further comprising a third filter media comprising a carbonate salt of calcium, wherein the third fluid media receives the volume of water after exiting the second filter media.

8. The device of claim 1, wherein the weakly basic anion exchange resin comprises activated carbon from a non-coal source and the acidic cation exchange resin is devoid of activated carbon.

9. A supply water treatment system comprising:
a Point of Entry unit fluidically coupled to a dwelling's supply water, the Point of Entry unit comprising
a particulate filter media capable of reducing the level of particulates in the volume of water; and
a redox filter media capable of chemically reducing or chemically oxidizing at least one component in the volume of water; and
at least one Point of Use unit, the at least one Point of Use unit fluidically coupled to the Point of Entry unit, the at least one Point of Use unit comprising:
a first filter media comprising an acidic cation exchange resin capable of exchanging at least a portion of metal cations in the volume of water with non-metal cations such that the volume of water exiting the first filter media is reduced in metal cation content; and
a second filter media comprising a weakly basic anion exchange resin capable of exchanging at least a portion of the basic anions in the volume of water;
wherein the first filter media or the second filter media are optionally mixed with a particulate activated carbon.

10. The system of claim 9, further comprising at least one water-permeable casing for separating the first filter media from the second filter media.

11. The system of claim 9, wherein the acidic cationic exchange resin is selected from the group consisting of crosslinked polystyrenes functionalized with sulphonic acid groups.

12. The system of claim 9, wherein the weakly basic anionic resin is selected from the group consisting of crosslinked polystyrenes functionalized with tertiary amine.

13. The system of claim 9, wherein the particulate filter media is a silica having a bulk density of about 24-26 pounds per cubic foot, and a density of about 2.25 grams per cubic centimeter.

14. The system of claim 9, wherein the redox filter media is a copper-zinc alloy.

15. The system of claim 9, further comprising a third filter media comprising a carbonate salt of calcium, wherein the third fluid media receives the volume of water after exiting the second filter media.

16. The system of claim 9, wherein the weakly basic anion exchange resin comprises activated carbon from a non-coal source and the acidic cation exchange resin is devoid of activated carbon.

17. A method of treating water comprising the steps of:
contacting a volume of water with a first filter media optionally mixed with activated carbon, wherein at least a portion of metal cations present in the volume of water are exchanged with non-metal cations in the first filter media such that the volume of water exiting the first filter media is reduced in metal cation content; and
contacting the volume of water with a second filter media comprising a weakly basic anion exchange resin optionally mixed with activated carbon, wherein at least a portion of anions present in the volume of water are exchanged with anions of the second filter media, the first and second filter media being in fluid communication with each other,
whereby the volume of water evaporates without leaving visible residue.

18. The method of claim 12, wherein the volume of water exits the first filter media before contacting the second filter media, wherein the volume of water exiting the second filter media is reduced in metal cations and halogen anions such that the volume of water evaporates essentially spotless.

19. The method of of claim 12, further comprising contacting the volume of water after contacting the second filter media with a carbonate salt of calcium, wherein at least a portion of the volume of water is increased in the amount of calcium cation, whereby the palatability of the volume of water is improved.

20. The method of of claim 12, wherein the first filter media is an acidic cationic exchange resin selected from the group consisting of crosslinked polystyrenes functionalized with sulphonic acid groups, the first filter media exchanging at least some protons with the metal cations of the volume of water; and wherein the second filter media is a weakly basic anionic resin selected from the group consisting of crosslinked polystyrenes functionalized with tertiary amine, the second filter media exchanging at least some hydroxide ions with the halogen anions of the volume of water.
